(19) United States
(12) Patent Application Publication
(10) Pub. No.: US 2026/0141879 A1
(43) Pub. Date: May 21, 2026

(54) MUSICAL INSTRUMENT FRETBOARD AND METHOD OF MANUFACTURE THEREOF

(71) Applicant: Marcodi Musical Products, LLC, Hydes, MD (US)

(72) Inventors: Timothy E. Meeks, Hydes, MD (US); Connor J. Meeks, Perry Hall, MD (US)

(73) Assignee: Marcodi Musical Products, LLC, Hydes, MD (US)

(21) Appl. No.: 19/341,367

(22) Filed: Sep. 26, 2025

Related U.S. Application Data
(60) Provisional application No. 63/700,865, filed on Sep. 30, 2024.

(51) Int. Cl. G10D 1/05; G10D 3/06

(52) U.S. Cl. CPC G10D 1/05; G10D 3/06

(57) ABSTRACT

A musical instrument includes a fretboard with fret channels in an upper surface, a number of frets attached to the fretboard in the plurality of fret channels, a number of compliant elements located in the fret channels, and a support structure configured to support strings in tension over the fretboard and the frets. Each fret is attached to the fretboard by adhesive applied to the fret channel or to the fret. A fret covers one or more compliant elements. And extends above the upper surface of the fretboard. Frets may be attached to the fretboard by supporting a block on the plurality of frets and compressing the compliant elements in the fret channels while the adhesive sets. The lower surface of the block is a planar reference surface.

### BACKGROUND

Musical instruments, such as guitars, basses, banjos, incorporate a number of strings held in tension over a fretboard. Pressing a string against a fret mounted in the fretboard alters the free-length of the string and changes the frequency of the sound it produces. Conventionally, the process of installing the frets is very labor-intensive. For example, a spooled, malleable fret-wire may be used. The cross-section of the wire looks like a mushroom, with a bead or crown supported on a stud that is embedded in the fretboard.

In one example installation, fret-wire is cut to length and the ends are rounded if desired for cosmetic enhancement. Tangs of the fret-wire may be ripple-crimped in key places to create higher hold, but this adds cost and makes insertion more difficult. Glue is applied to the fret channels and the wire is hammered into fret channel. The malleable fret-wire conforms to the non-flat, typically wooden, substrate of the fretboard. On a guitar, the substrate is called the ‘neck’. The hammering process inevitably results in some places where the fret-wire is hammered in all the way and other spots where the fret-wire is not completely inserted. Tops of frets are marked with a red marker and the fret tops are leveled using stick-on abrasives on a flat tool until all red marker traces have been removed. The fret tops are then crowned (re-rounded) using a semi-circular file. The frets are then polished with increasingly fine abrasives and finally polished with steel wool.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a diagram of a Harpejji® musical instrument.

FIG. 2 is a perspective view of a Harpejji® musical instrument.

FIG. 3 is a simplified top view of a fretboard with attached frets.

FIGS. 4A, 4B, 4C, 4D, 4E show cross-sectional views of a fretboard and frets, in accordance with various representative embodiments.

FIG. 5 is a further cross-sectional view of a fretboard and frets, in accordance with various representative embodiments.

FIG. 6 is a top view of a Harpejji® body, in accordance with various representative embodiments.

FIG. 7 shows more detail of a fret channel, in accordance with various representative embodiments.

FIG. 8 is a top view of a Harpejji® body, in accordance with various representative embodiments.

FIG. 9 is a view of a body of a Harpejji® musical instrument, in accordance with various representative embodiments.

FIG. 10 is a view showing frets located in fret channels of fretboard and supporting marble slab, in accordance with various representative embodiments.

FIG. 11 is view of a Harpejji® with attached strings, in accordance with various representative embodiments.

### DETAILED DESCRIPTION

The disclosure relates to a fretted musical instrument and various methods for attaching frets to a fretboard of a musical instrument.

An embodiment method includes, for each fret channel of a number of fret channels in an upper surface of a fretboard: placing one or more compliant elements in the fret channel; applying adhesive to the fret channel or a fret of a plurality of frets; and adhering the fret in the fret channel. The fret is supported by the one or more compliant elements in the fret channel and extends above the upper surface of the fretboard. While the adhesive sets, a block is supported on the frets such that the block compresses the compliant elements and the frets contact a lower surface of the block. The lower surface of the block provides a reference surface, which may be planar. The one or more compliant elements may remain in the fret channels beneath the frets after the adhesive has set. The fret channels in the upper surface of the fretboard may be formed by routing, for example.

A fret may be a rod with one or more guideposts extending in a perpendicular direction from the rod. In this embodiment, the method includes forming one or more blind holes at the bottom of each fret channel and, for each fret channel, adhering the fret in the fret channel includes placing the one or more guideposts of the fret in corresponding blind holes in the fret channel.

In one embodiment, the block is a stone slab, but other materials may be used.

One or more weights may be rested on the block to adjust the height of the reference surface above the fret board to a designated height. In turn, this ensures that the frets extend a designated height above the fretboard.

A compliant element may be, for example, a foam pad, a rubber pad, a bent spring steel strip, a helical spring, a dished spring steel washer, or a leaf spring. Other compliant elements may be used without departing from the present disclosure. The compliance of the compliant elements and the weight of the slab are chosen together to ensure that the frets remain a designated height above the fretboard.

An embodiment of the disclosure provides a musical instrument including a fretboard with multiple of fret channels in an upper surface of the fretboard, a number of frets attached to the fretboard in the fret channels, a number of compliant elements located in the fret channels, and a support structure configured to support strings in tension over the fretboard and the plurality of frets. The frets are attached to the fretboard by a method such as the method described above

In one embodiment, a fret is rod with a cylindrical cross-section. A cross-section of a fret channel may be rectangular, for example. A fret channel is sized to receive a fret.

Embodiments of the disclosure provide a fretboard having of fret channels in an upper surface of the fretboard. Frets are attached to the fretboard in the fret channels. Compliant elements are located in the fret channels beneath the frets. A compliant element may be a foam pad, a rubber pad, a bent spring steel strip, a helical spring, a dished spring steel washer, or a leaf spring, for example. Other compliant elements may be used. A support structure configured to support a plurality of strings in tension over the fretboard and the plurality of frets.

Each fret is attached to the fretboard by adhesive applied to the fret channel or to the fret. Each fret covers one or more of the compliant elements and extends above the upper surface of the fretboard.

As described above, the frets may be attached to the fretboard by supporting a block on the frets and compressing the compliant elements in the fret channels while the adhesive sets. The lower surface of the block may be a planar reference surface that forces the upper surface of the fret to lay in a common plane.

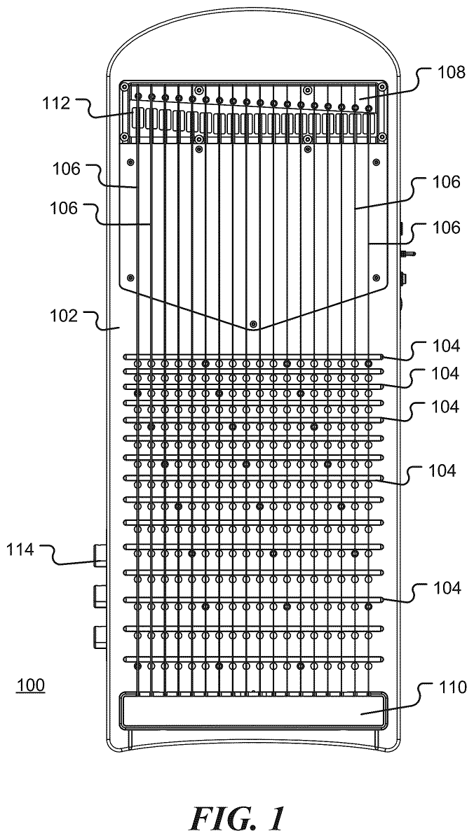

FIG. 1 is a diagram of a Harpejji® musical instrument 100. The instrument includes a fret board or body 102 attached to which are a number of frets 104. Strings 106 are held in tension above the frets and fretboard by support structures 108 and 110. Vibration sensors 112, such as piezo electric sensors, produce electrical signals that are amplified to produce the sound of the instrument. User controls 114 are provided to allow user-adjustment of sound volume and tone etc.

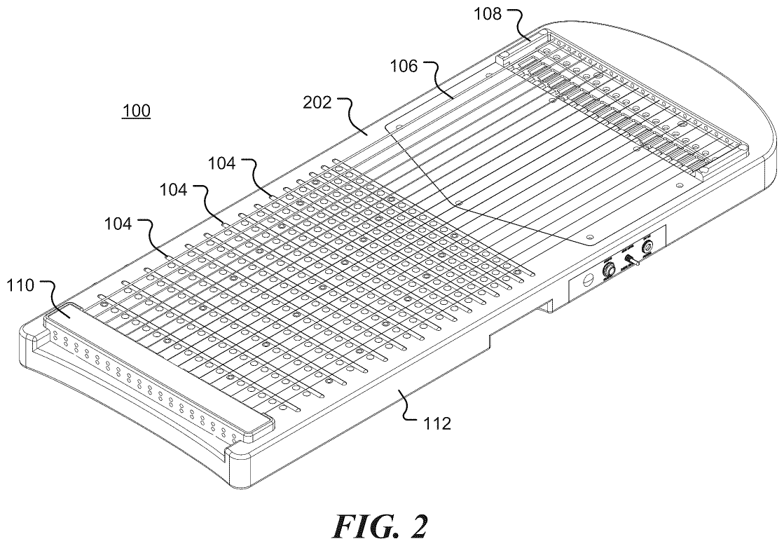

FIG. 2 is a perspective view of Harpejji®100. Fretboard or body 102 has an upper surface 202.

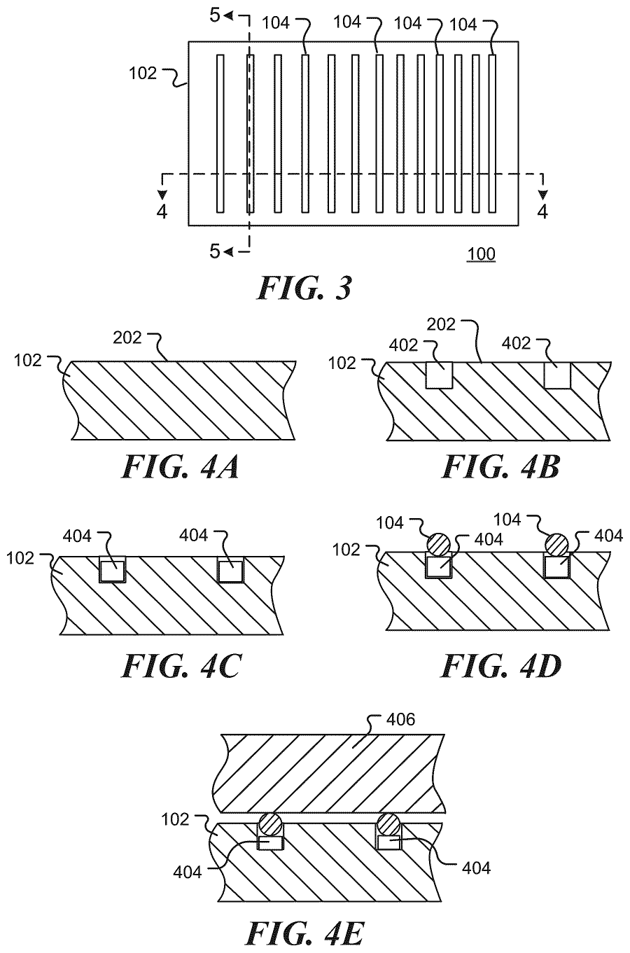

FIG. 3 is a simplified top view of a fretboard 102 with attached frets 104.

FIGS. 4A, 4B, 4C, 4D, 4E show cross-sectional views through section 4-4 shown in FIG. 3 at various stages of manufacture, in accordance with various representative embodiments.

FIG. 4A shows fretboard 102 with upper surface 202.

FIG. 4B shows fretboard 102 with transverse slots or fret channels 402 formed in upper surface 202. These may be formed by routing, for example. In this embodiment, the slots or fret channels have a rectangular cross-section. Advantages of a rectangular cross-section may include ease of routing strings and ease of attachment to pads, for example.

FIG. 4C shows fretboard 102 with compliant pads 404 placed in the transverse slots or fret channels 402.

FIG. 4D shows fretboard 102 with frets 104 supported on the compliant pads 404. An adhesive, such as wood glue or hide glue, is placed in the slots. Due to manufacturing tolerances, such as the evenness of the fretboard, the depth of the slots, the thickness of the pads and the amount of adhesive for example, the frets are not co-planar at this stage.

FIG. 4E shows fretboard 102 with a block 406 placed on top of the frets 104 and supported by the frets before the adhesive sets. The lower surface of block 406 is a reference surface. The reference surface may be curved or have some other shape to match desired fret positions. In this embodiment, block 406 has a planar lower surface and may be, for example, a stone slab, such as a granite slab. The weight of block 406 presses on the frets causing them to compress the compliant pads 404. The pads have sufficiently low compliance that they are all compressed to some degree, and sufficiently high compliance that none are fully compressed. As a result, the tops of all of the frets contact the reference surface of block 406 along their entire length and are co-planar with the reference block. The block is removed after the adhesive has set, leaving co-planar frets.

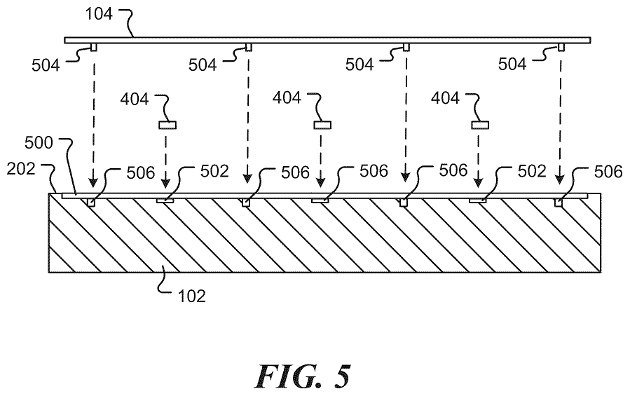

FIG. 5 is a cross-sectional view through section 5-5 in FIG. 3, in accordance with various representative embodiments. FIG. 5 illustrates the attachment of fret 104 to a fretboard or body 102. Fret channel 500 is formed in the top surface 202 of fretboard 102. Hollows 502 are formed at the bottom of fret channel 500 to receive compliant pads 404 (as indicated by the broken arrows). Fret 104 has a number of guideposts 504 extending perpendicular to its length. These guidepost are positioned in corresponding blind holes 506 formed in the bottom of fret channel 500. This allows for vertical motion of the fret to allow leveling, but restriction horizontal motion, which is undesirable.

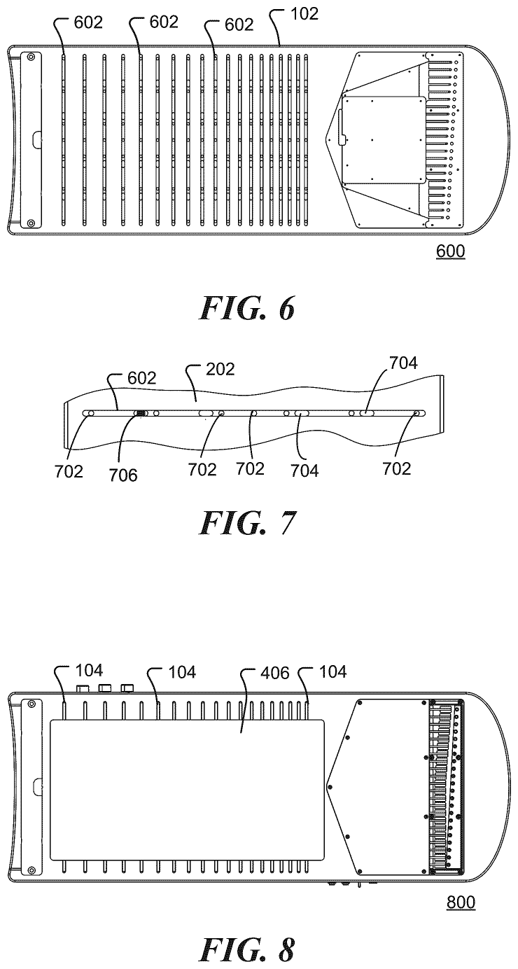

FIG. 6 is a top view of a Harpejji® body 600, in accordance with various representative embodiments. Multiple fret channels 602 are formed in the top surface of the body.

FIG. 7 shows more detail of a fret channel 602, in accordance with various representative embodiments. This shows blind holes 702 for receiving fret guidepost, and hollows 704 for receiving compliant pads, such as compliant pad 706.

FIG. 8 is a top view of a Harpejji® 800, in accordance with various representative embodiments. This view shows block 406 (such as a granite slab) supported on frets 104 while adhesive attaching the frets to the body sets.

Embodiments of the present disclosure provide a method of attaching frets to a fretboard without a need for markerboard pocket or markerboard. The approach used fret channels just slightly wider than the frets. Compliant pads that act as springs are placed into the fret channels. The pads are not removed, but remain buried under the fret. The final appearance of the instrument is cleaner and sleeker. For example, the surface of a wooden fretboard remains visible.

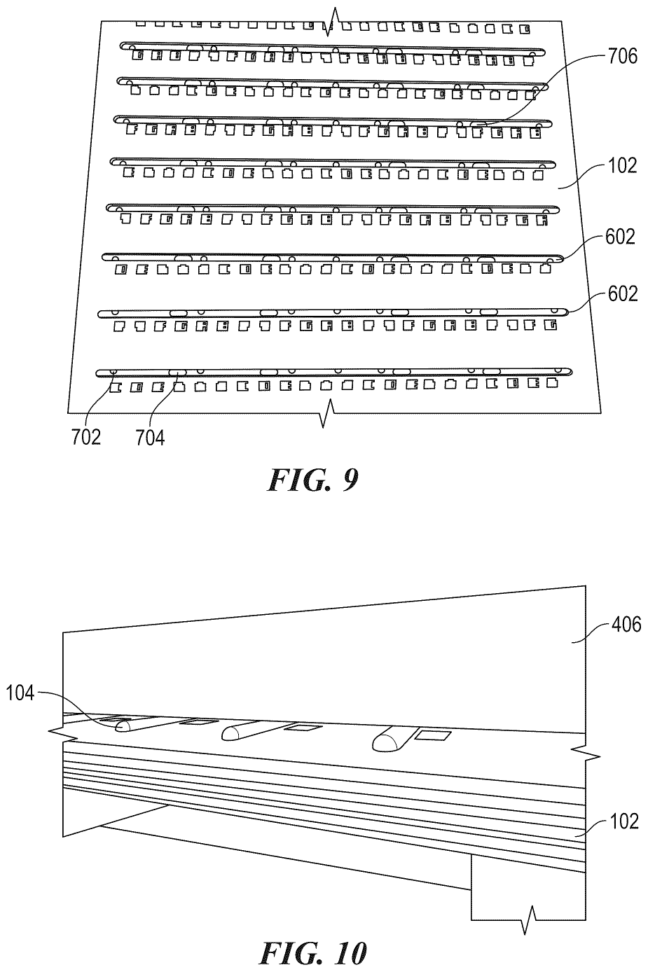

FIG. 9 is photograph of a body 102 of a Harpejji® musical instrument, showing fret channels 602 in the body, in accordance with various representative embodiments. The channels have blind holes 702 for receiving fret guidepost and hollows 704 for receiving compliant pads, such as foam pad 706.

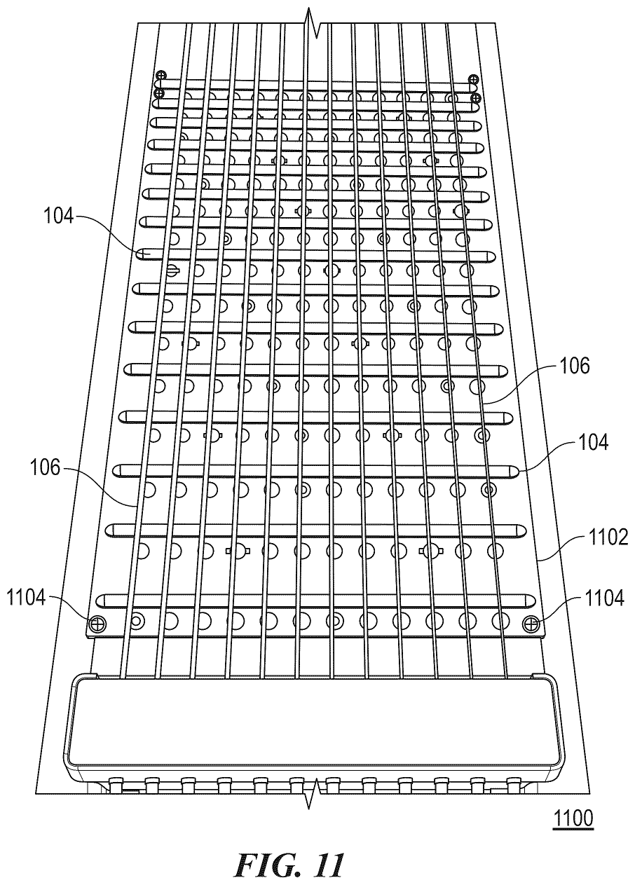

FIG. 10 is photograph showing frets 104, located in fret channels of Harpejji® body 102, supporting marble slab 406, in accordance with various representative embodiments. Compliant pads in fret channels in the body allow the fret to be held in contact with and co-planar with the marble slab until and adhesive sets.

The present disclosure provides a new way to make a fretted instrument and results in a more beautiful fretboard that is part of the body.

The compliant pads may be rubber springs, spring steel, solid or foam rubber, or other compliant material.

In an alternative embodiment, reuseable springs are that can be removed from access holes in the underside of the fretboard. However, this requires drilling a lot of thru-holes in the fretboard, which may be expensive. In addition, it may be desirable to cover all of those access holes with a cover held in by screws that require screw holes in the body. This results in additional labor and material costs.

An alternative approach, used to construct a Harpejji® for example, uses harder/stiffer/thicker/straighter machined fret rods rather than traditional fret wire. The fret rods contain threaded holes to accept little set screws. A wooden fret-board has a routed pocket to accept a cosmetic cover or marker board. Between two and four rubber strips are laid down in the pocket, perpendicular to the frets and spanning more than all frets, to be used as springs under the fret rods. Glue is laid down in the (much larger than traditional) fret channels, which also contains several blind drill holes. Fret rods are inserted so that their attached set screws go into blind holes. A granite slab, or other block, is laid on top of all the frets and the rubber springs push the frets up to the flat granite surface. The glue dries over 24 hours after which time the granite is removed. The rubber strips are grabbed between frets and removed completely, and the cover is laid over the frets to cosmetically cover the unsanded, rough routed pocket in the body.

FIG. 11 shows a Harpejji® 1100 with cosmetic cover 1102 attached with screws 1104. In this example, cover 1102 is a marker board. Strings 106 are held in tension above frets 104.

An embodiment of the method includes forming a plurality of fret channels in an upper surface of a fretboard and, for each fret channel of the plurality of fret channels, placing one or more compliant pads in the fret channel. Adhesive is applied to the fret channel or a fret of a plurality of frets, adhering the fret in the fret channel. The fret is supported by the one or more compliant pads in the fret channel and extends above the upper surface of the fretboard. While the adhesive sets, a block having a planar lower surface is supported on the plurality frets, with the block compressing the compliant pads such that the plurality of frets contact and are co-planar with the planar reference surface of the block. The block may be a stone slab, for example.

A fret may be a rod with one or more guideposts extending in a perpendicular direction from the rod, and the method may include forming one or more blind holes at the bottom of each fret channel, and for each fret channel, adhering the fret in the fret channel includes placing the one or more guideposts of the fret in corresponding one or more blind holes in the fret channel.

The fretboard may be used in a musical instrument, such as an Harpejji®.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method comprising:
for each fret channel of a plurality of fret channels in an upper surface of a fretboard:
placing one or more compliant elements in the fret channel;
applying adhesive to the fret channel or a fret of a plurality of frets; and
adhering the fret in the fret channel, the fret supported by the one or more compliant elements in the fret channel and extending above the upper surface of the fretboard; and
while the adhesive sets, supporting a block on the plurality frets, the block compressing the compliant elements such that the plurality of frets contact a lower surface of the block, where the lower surface of the block is a reference surface.

2. The method of claim 1, where the one or more compliant elements remain in the fret channels beneath the frets after the adhesive has set.

3. The method of claim 1, further comprising forming the plurality of fret channels in the upper surface of the fretboard.

4. The method of claim 1, where the lower surface of the block is a planar reference surface.

5. The method of claim 1, where a fret of the plurality of frets comprises a rod with one or more guideposts extending in a perpendicular direction from the rod and the method includes:
forming one or more blind holes at the bottom of each fret channel; and
for each fret channel, adhering the fret in the fret channel includes placing the one or more guideposts of the fret in corresponding one or more blind holes in the fret channel.

6. The method of claim 1, where the block is a stone slab.

7. The method of claim 1, where the lower surface of the block is a planar reference surface, the method further comprising adding one or more weights to the block to adjust the height of the reference surface above the fret board to a designated height.

8. The method of claim 1, where a compliant element of the plurality of compliant elements is a foam pad, a rubber pad, a bent spring steel strip, a helical spring, a dished spring steel washer, or a leaf spring.

9. A musical instrument comprising:
a fretboard having a plurality of fret channels in an upper surface of the fretboard;
a plurality of frets attached to the fretboard in the plurality of fret channels;
a plurality of compliant elements located in the plurality of fret channels; and
a support structure configured to support a plurality of strings in tension over the fretboard and the plurality of frets;
where the plurality of frets are attached to the fretboard by a process including:
for each fret channel of the plurality of fret channels:
applying adhesive to the fret channel or a fret of the plurality of frets; and
adhering the fret in the fret channel, the fret supported by the one or more compliant elements in the fret channel and extending above the upper surface of the fretboard; and
while the adhesive sets, supporting a block on the plurality frets, the block compressing the compliant elements such that the plurality of frets contact a lower surface of the block.

10. The musical instrument of claim 9 where the lower surface of the block is a reference surface and the one or more compliant elements remain in the plurality of fret channels beneath the frets after the adhesive has set.

11. The musical instrument of claim 9, where the lower surface of the block is a planar reference surface.

12. The musical instrument of claim 9, where:
a fret of the plurality of frets comprises a rod with one or more guideposts extending in a perpendicular direction from the rod;
each fret channel of the plurality of fret channels has one or more blind holes formed at the bottom of the fret channel; and
the process of attaching the frets to the fretboard includes, for each fret channel, adhering the fret in the fret channel includes placing the one or more guideposts of the fret in corresponding one or more blind holes in the fret channel.

13. The musical instrument of claim 9, where a compliant element of the two or more compliant elements is a foam pad.

14. The musical instrument of claim 9, where a fret of the plurality of frets includes a cylindrical rod.

15. The musical instrument of claim 9, where a cross-section of a fret channel is rectangular.

16. A musical instrument comprising:
a fretboard having a plurality of fret channels in an upper surface of the fretboard;
a plurality of frets attached to the fretboard in the plurality of fret channels;
a plurality of compliant elements located in the fret channels; and
a support structure configured to support a plurality of strings in tension over the fretboard and the plurality of frets;
where each fret of the plurality of frets is attached to the fretboard by adhesive applied to the fret channel or a fret of the plurality of frets, and each fret of the plurality of frets is supported by one or more of the plurality of compliant elements and extends above the upper surface of the fretboard.

17. The musical instrument of claim 16, where the plurality of frets is attached to the fretboard by supporting a block on the plurality of frets and compressing the plurality of compliant elements in the fret channels while the adhesive sets and where the lower surface of the block is a planar reference surface.

18. The musical instrument of claim 16, where a fret of the plurality of frets includes a cylindrical rod.

19. The musical instrument of claim 16, where a cross-section of a fret channel is rectangular.

20. The musical instrument of claim 16, where a compliant element of the plurality of compliant elements is a foam pad, a rubber pad, a bent spring steel strip, a helical spring, a dished spring steel washer, or a leaf spring.
